(19) United States
(12) Patent Application Publication
(10) Pub. No.: US 2025/0060241 A1
(43) Pub. Date: Feb. 20, 2025

(54) A DYNAMIC WEIGHING SYSTEM OF A VEHICLE

(71) Applicant: Roberto IMPERO, ACERRA (IT)

(72) Inventor: Pasquale IMPERO, ACERRA (IT)

(21) Appl. No.: 18/721,845

(22) PCT Filed: Dec. 16, 2022
(86) PCT No.: PCT/IB2022/062389

§ 371 Date: Jun. 19, 2024

(30) Foreign Application Priority Data
Dec. 20, 2021 (IT) 102021000031775

(51) Int. Cl. G01G 19/02

(52) U.S. Cl. CPC G01G 19/022

(57) ABSTRACT

A dynamic weighing system of a vehicle comprises a beam having a hollow longitudinal body; first and second end portions comprising a part of the relative neutral axis of the beam; an upper rest surface for receiving the vehicle wheel in transit; first and second lower rest surfaces; the first and second lower rest surfaces being opposite the upper rest surface and extending on the horizontal plane defined by the neutral axis of the beam. A base beneath the road surface comprises a seat to receive the beam; a plurality of compression load cells interposed between the base and the beam so that a first compression load cell supports the beam at the first lower rest surface and a second compression load cell supports the beam at the second lower rest surface; a plurality of abutments between the beam and the lateral walls of the seat.

### FIELD OF THE INVENTION

The present invention relates to the technical sector concerning the weighing of vehicles.

In particular, the present invention relates to a dynamic weighing system of a vehicle.

### DESCRIPTION OF THE PRIOR ART

It is known that trucks, like other heavy vehicles, when exceeding the regulation weight limits, increase the risk of accidents and damage to infrastructures.

It is therefore necessary to guarantee conformity of the load to the rules of the law relating to heavy vehicles. This can be done with traditional static weighing systems of a vehicle which, however, present obvious limits: they slow down vehicular traffic and do not enable a real-time measurement to be made. To obviate these drawbacks, dynamic weighing systems of a vehicle are known which instead enable weighing the vehicles in motion in the flow of vehicular traffic, without interrupting the viability.

These dynamic weighing systems are especially useful in road interchanges where a large quantity of heavy vehicles circulate.

Further, the real-time detected data from the dynamic weighing systems enable management in short times of any “overloaded” transiting on the infrastructures.

Today dynamic weighing systems of a vehicle are known which require a complex processing of the detected datum, i.e. the value of the force exerted by the wheels of the vehicle in transit. These dynamic weighing systems include the transit of a vehicle on a platform which is supported by load cells and which is arranged internally of a peripheral frame, in such a way that the load cells detect the force exerted by each wheel of the vehicle during the transit of the vehicle, then to translate the vertical movement of the platform with respect to the peripheral frame into a weight measurement exerted on the platform, i.e. the mass of the vehicle in transit.

Each load cell detects a value of the force acting which comprises, as well as the vertical component of the force exerted by the wheel, further components relating, for example, to the traction or torsion or torque to which the platform is subjected during the transit of the vehicle.

For this reason, these known dynamic weighing systems require, before the processing of the datum detected to determine the mass of the vehicle, a preliminary processing of the value of the force detected with the purpose of correlating the components extraneous to the vertical component of the force thereto.

This requires the use of complex calculation algorithms.

### SUMMARY OF THE INVENTION

In the light of the above, the aim of the present invention consists in obviating the above-mentioned drawbacks.

An aim of the present invention is to obtain a dynamic weighing system of a vehicle that is able to simplify the work required for the processing of the datum detected to determine the mass of the vehicle.

The above aims are attained by use of a dynamic weighing system of a vehicle according to claim 1.

The beam is advantageously arranged resting by the ends thereof, at the first end portion and at the second end portion, on the at least a first compression load cell and on the at least a second compression load cell, with the relative first lower rest surface and the relative second lower rest surface, extending along the horizontal plane defined by the neutral axis of the beam.

In this way, the at least a first compression load cell and the at least a second compression load cell directly measure the vertical component of the force exerted by the wheel of the vehicle in transit on the beam, as they are arranged to detect the value of the force along the neutral axis which, by definition, is not subject to any movement either by lengthening or shortening, but only flexion.

Further, the plurality of abutments interposed between the beam and the lateral walls of the seat limit the displacements of the beam along a transversal direction to the relative longitudinal axis of the hollow longitudinal body, which might be prompted due to the oscillations or vibrations generated by the vehicle in transit. In this way, any horizontal components of forces acting on the compression load cells are reduced, as the presence thereof would lead to the generation of an error in the measurement of the vertical component of the force by the compression load cell.

### BRIEF DESCRIPTION OF THE DRAWINGS

Specific embodiments of the invention will be described in the following part of the present description, according to what is set down in the claims and with the aid of the accompanying tables of drawings, in which:

FIGS. 1-3 are perspective and lateral views of the dynamic weighing system of a vehicle, object of the present invention;

FIGS. 4-6 are perspective and lateral views of the dynamic weighing system of a vehicle, object of the present invention, from which some components have been removed better to highlight others;

FIG. 7 is a section view along plane VII-VII of FIG. 3;

FIG. 8 is an enlarged view of detail K of FIG. 7;

FIGS. 9-12 are perspective and lateral views of the beam;

FIG. 13 is an exploded view of the dynamic weighing system of a vehicle, object of the present invention;

FIG. 14 is a plan view of the dynamic weighing system of a vehicle, object of the present invention, comprising two pairs of beams.

### DESCRIPTION OF PREFERRED EMBODIMENTS

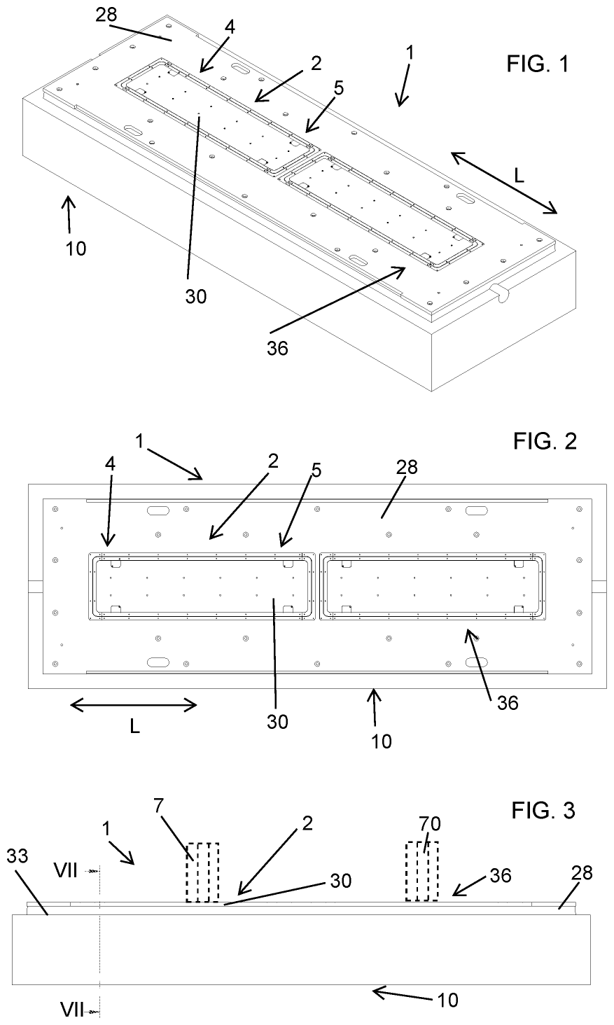

With reference to the appended tables of drawings, reference numeral (1) denotes a dynamic weighing system of a vehicle comprising: a beam (2), in turn comprising: a hollow longitudinal body (3); a first end portion (4) and a second end portion (5) which are opposite one another and parallel to one another and which comprise a part of the relative neutral axis (N) of the beam (2); the first end portion (4) and the second end portion (5) having a transversal section that is smaller than the transversal section of the remaining portion of the beam (2); an upper rest surface (6) for receiving the wheel (7) of a vehicle in transit; a first lower rest surface (8) which is arranged at the first end portion (4) and a second lower rest surface (9) which is arranged at the second end portion (5); the first lower rest surface (8) and the second lower rest surface (9) being opposite the upper rest surface (6) and extending on the horizontal plane defined by the neutral axis (N) of the beam (2) (see FIGS. 1-3, 6 and 9-12). Further, the dynamic weighing system of a vehicle (1) comprises: a base (10) to be arranged in such a way as to be beneath the road surface and comprising a seat (11) conformed so as to receive the beam (2); a plurality of compression load cells (42) which are interposed between the base (10) and the beam (2) in such a way that at least a first compression load cell (12) supports the beam (2) at the first lower rest surface (8) and the at least a second compression load cell (13) supports the beam (2) at the second lower rest surface (9);
a plurality of abutments (14) which are interposed between the beam (2) and the lateral walls of the seat (11) so as to limit the displacements of the beam (2) along a transversal direction to the relative longitudinal axis (L) (see FIGS. 1-3, 6-8 and 13).

The dynamic weighing system of a vehicle (1) is configured in such a way that, during the transit of a wheel (7) of the vehicle on the upper rest surface (6), the at least a first compression load cell (12) and the at least a second compression load cell (13) detect the force exerted when abutting, respectively, the first lower rest surface (8) and the second lower rest surface (9) (see FIGS. 1-3, 6-8 and 13).

The term dynamic weighing system of a vehicle (1) is understood to refer to a system for determining the weight of a vehicle in transit on a stretch of road or on a bridge.

In other words, the determination of the weight takes place during the transit of the vehicle and, thus, without the vehicle stopping.

By vehicle is meant a heavy vehicle and refers, for example, to a truck or lorry.

By neutral axis is meant the intersection between the neutral plane (the locus of points for which the normal tensions are zero) and the plane of the generic section on which it acts.

It is known that in a beam subjected to flexion, unitary tensions of traction and compression are created, ideally separated by a layer of fibres termed “neutral axis”, which layer is subject to no lengthening or shortening movement.

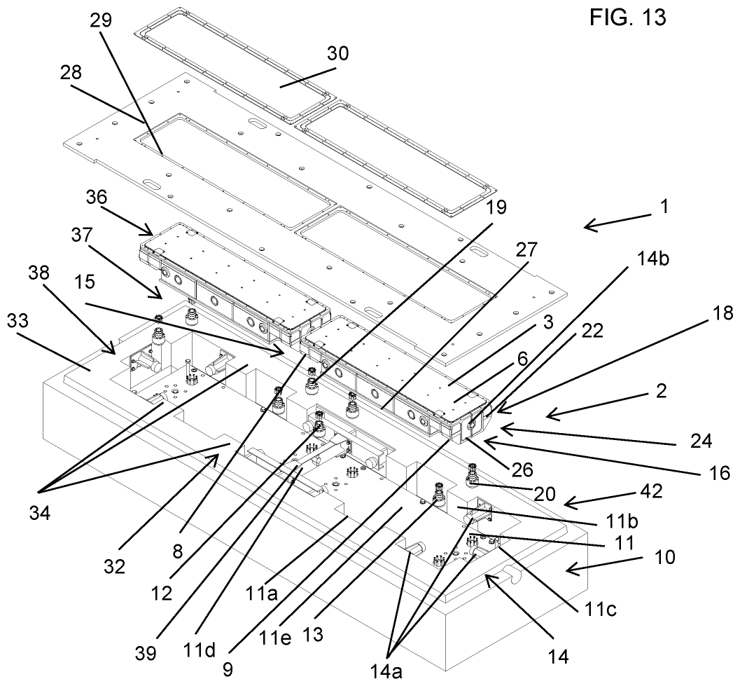

It is specified that the beam (2) can be considered rested at the ends thereof on the compression load cells (12, 13) of the plurality of compression load cells (42), which is subjected a flexion as a function of the force applied by the vehicle during the relative transit (see FIGS. 3 and 13).

The at least a first compression load cell (12) and the at least a second compression load cell (13) detect the force exerted when abutting, respectively, the first lower rest surface (8) and the second lower rest surface (9).

The first lower rest surface (8) and the second lower rest surface (9) can be parallel to the first upper rest surface (6).

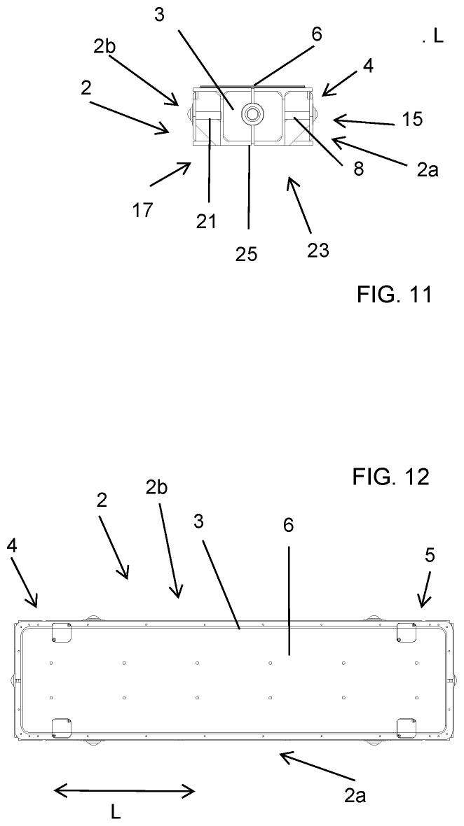

The transversal section of the first end portion (4) and the second end portion (5) can be identical to one another (see FIGS. 9-12).

The seat (11) can comprise a first pair of lateral walls (11a, 11b) which are opposite one another and a second pair of lateral walls (11c, 11d) which are opposite one another and which conjoin the lateral walls of the first pair of lateral walls (11a, 11b) (see FIG. 13).

Further, the seat (11) can comprise a bottom wall (11e) which connects the first pair of lateral walls (11a, 11b) and the second pair of lateral walls (11c, 11d) to one another (see FIG. 13).

Each compression load cell (12, 13) of the plurality of compression load cells (42) can be fixed to the bottom wall (11e) (see FIG. 13).

Each abutment of the plurality of abutments (14) can be fixed to the first pair of lateral walls (11a, 11b) and to the second pair of lateral walls (11c, 11d) of the seat (11) (see FIG. 13).

During the use of the dynamic weighing system of a vehicle (1), when the beam (2) is received in the seat (11), the base (10) and the beam (2) are arranged underlying the road surface.

With particular reference to the load cells, it is known that a load cell is an electronic component used to measure a force applied on an object by measuring an electric signal which varies due to the deformation that the force produces on the object.

In the case under consideration, a compression load cell can detect the mechanical deformation under compression of an object. The first end portion (4) can comprise a first step (15) that extends at least partially along a first longitudinal edge (2a) of the beam (2); the second end portion (5) can comprise a second step (16) that extends at least partially along the first longitudinal edge (2a) of the beam (2) (see FIGS. 9 and 13). Further, the at least a first compression load cell (12) can be arranged to abut the first step (15) and the at least a second compression load cell (13) can be arranged to abut the second step (16) (see FIG. 13).

In other words, the first lower rest surface (8) can be borne by the first step (15).

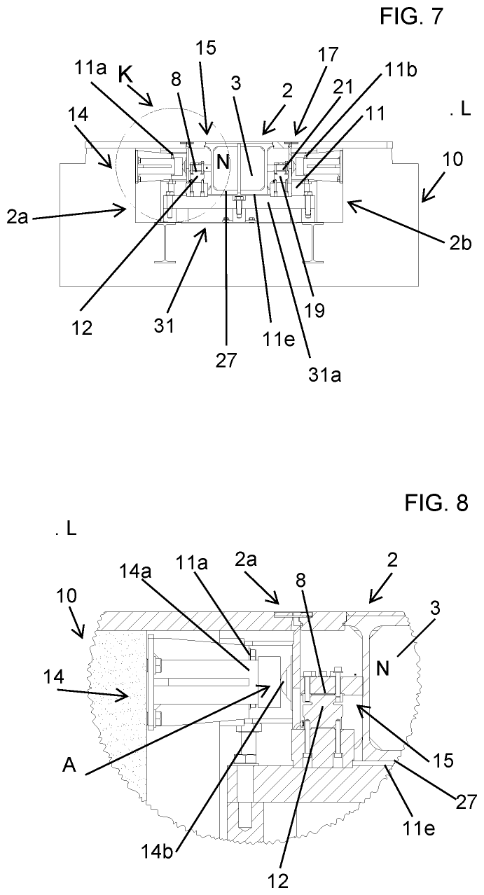

The second lower rest surface (9) can be borne by the second step (16). The first end portion (4) preferably comprises a third step (17) which is opposite the first step (15) and which extends at least partially along a second longitudinal edge (2b) of the beam (2); the second end portion (5) comprises a fourth step (18) which is opposite the second step (16) and which extends at least partially along the second longitudinal edge (2b) of the beam (2); the plurality of compression load cells (42) comprises: a third compression load cell (19) which is arranged so as to abut the third step (17) and a fourth compression load cell (20) which is arranged so as to abut the fourth step (18) (see FIGS. 7, 9 and 13).

According to a preferred embodiment, the dynamic weighing system of a vehicle (1) comprises four compression load cells (12, 13, 19, 20) and the beam (2) comprises a third lower rest surface (21) which is arranged at the first end portion (4) and which is adjacent to the first lower rest surface (8) and a fourth lower rest surface (22) which is arranged at the second end portion (5) and which is adjacent to the second lower rest surface (9) (see FIGS. 7, 9 and 13).

The third lower rest surface (21) can be borne by the third step (17).

The fourth lower rest surface (22) can be borne by the fourth step (18).

The third compression load cell (19) can support the beam (2) at the third lower rest surface (21) and the fourth compression load cell (20) can support the beam (2) at the fourth lower rest surface (22) (see FIG. 13).

The first lower rest surface (8) and the second lower rest surface (9) can extend along the first longitudinal edge (2a) of the beam (2).

The third lower rest surface (21) and the fourth lower rest surface (22) can extend along the second longitudinal edge (2b) of the beam (2).

The first step (15) and the third step (17) can be opposite one another with respect to the longitudinal axis (L).

The second step (16) and the fourth step (18) can be opposite one another with respect to the longitudinal axis (L).

The first step (15) and the third step (17) can be parallel to one another with respect to the longitudinal axis (L).

The second step (16) and the fourth step (18) can be parallel to one another with respect to the longitudinal axis (L).

The first end portion (4) preferably comprises a first projection (23) which is interposed between the first step (15) and the third step (17) and which is conformed so as to abut the base (10), when the beam (2) is received in the seat (11); the second end portion (5) comprises a second projection (24) which is interposed between the second step (16) and the fourth step (18) and which is conformed so as to abut the base (10), when the beam (2) is received in the seat (11) (see FIGS. 9-12 and 7, 8).

In detail, the first projection (23) and the second projection (24) abut the bottom wall (11e) of the seat (11) (see FIG. 13).

The first projection (23) comprises a fifth lower rest surface (25) which is arranged to abut the bottom wall (11e) of the seat (11), when the beam (2) is received in the seat (11) (see FIG. 13).

The second projection (24) comprises a sixth lower rest surface (26) which is arranged to abut the bottom wall (11e) of the seat (11), when the beam (2) is received in the seat (11).

The fifth lower rest surface (25) is interposed between the first lower rest surface (8) and the third lower rest surface (21) (see FIGS. 9 and 10).

The sixth lower rest surface (26) is interposed between the second lower rest surface (9) and the fourth lower rest surface (22) (see FIGS. 9 and 10).

In detail, when the beam (2) is received in the seat (11), the fifth lower rest surface (25) and the base (10) are in contact with one another.

Once more in detail, when the beam (2) is received in the seat (11), the sixth lower rest surface (26) and the base (10) are in contact with one another. The beam (2) can comprise a seventh lower rest surface (27), which conjoins the fifth lower rest surface (25) and the sixth lower rest surface (26) to one another and which is arranged so as to abut the base (10), when the beam (2) is received in the seat (11) (see FIGS. 9 and 10).

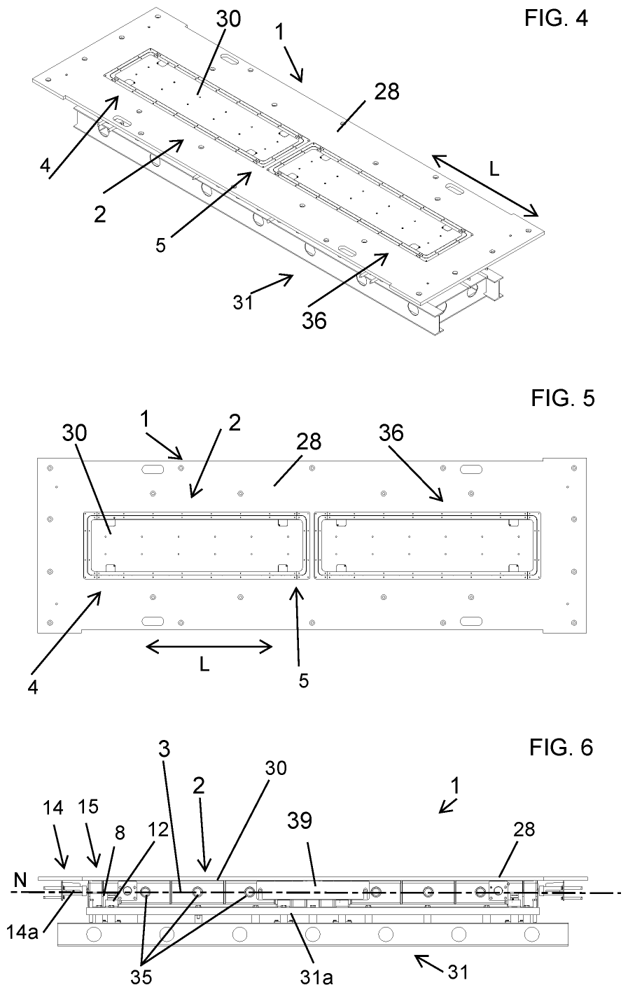

The dynamic weighing system of a vehicle (1) preferably comprises a first cover (28) conformed so as to superiorly cover the base (10) and comprising a through-opening (29) which is conformed and dimensioned so as to place the first upper rest surface (6) in communication with outside, when the first cover (28) covers the base (10) and the beam (2) is accommodated in the seat (11) (see FIGS. 4 and 5).

According to the above-described embodiment of the invention, the beam (2) is advantageously isolated with respect to the remaining parts of the dynamic weighing system (1) and the force exerted by the wheel (7) acts directly on the beam (2).

In other words, in this way, the action of the wheel (7) of the vehicle on the beam (2) is isolated.

The first cover (28) and the base (10) can be fixed to one another (see FIGS. 1-3, 13).

The first cover (28) can be made of metal.

The first cover (28) can be planar.

The dynamic weighing system of a vehicle (1) of the preceding claim, preferably comprises a second cover (30) conformed so as to cover the through-opening (29) (see FIGS. 1-3, 13).

The second cover (30) advantageously protects the first upper rest surface (6) from the outside, while at the same time ensuring the isolation of the beam (2) with respect to the remaining parts of the dynamic weighing system (1).

The second cover (30) and the first cover (28) can be fixed to one another (see FIGS. 1-3, 13).

The second cover (30) can be made of metal.

The second cover (30) can be planar.

The base (10) is preferably made of reinforced concrete.

Therefore the base (10) can comprise a plurality of metal sheets (31) incorporated in the concrete (see FIGS. 4-6).

The plurality of metal sheets (31) comprises a first metal sheet (31a) which is arranged so as to bear the plurality of compression load cells (42) and to restingly receive the fifth lower rest surface (25), the sixth lower rest surface (26) and the seventh lower rest surface (27).

The first metal sheet (31a) and each compression load cell (12, 13, 19, 20) of the plurality of compression load cells (42) can be fixed to one another (see FIGS. 1-3, 13).

The relative fixing can take place using screws and bolts.

FIGS. 4 and 5 illustrate the dynamic weighing system of a vehicle (1) in which the base (10) has been removed, so that the first cover (28), the second cover (30) and the plurality of metal sheets (31) are clearly visible.

FIG. 6 illustrates a lateral view of the dynamic weighing system of a vehicle (1) of FIGS. 4 and 5, so that the first metal sheet (31a) is clearly visible, the beam (2) and the at least a first compression load cell (12).

The lateral walls (11a, 11b, 11c, 11d) of the seat (11) can bear the abutments of the plurality of abutments (14), so as to laterally abut the beam (2).

In a preferred embodiment, the plurality of abutments (14) can comprise a plurality of rollers (14a) borne by the lateral walls (11a, 11b, 11c, 11d) of the seat (11) or the beam (2) and a plurality of rotatable spheres (14b) borne, respectively, by the beam (2) or the lateral walls (11a, 11b, 11c, 11d) of the seat (11) (see FIGS. 13, 6-8).

In this way, the phenomena of friction between the beam (2) and the lateral walls (11a, 11b, 11c, 11d) of the seat (11) are limited.

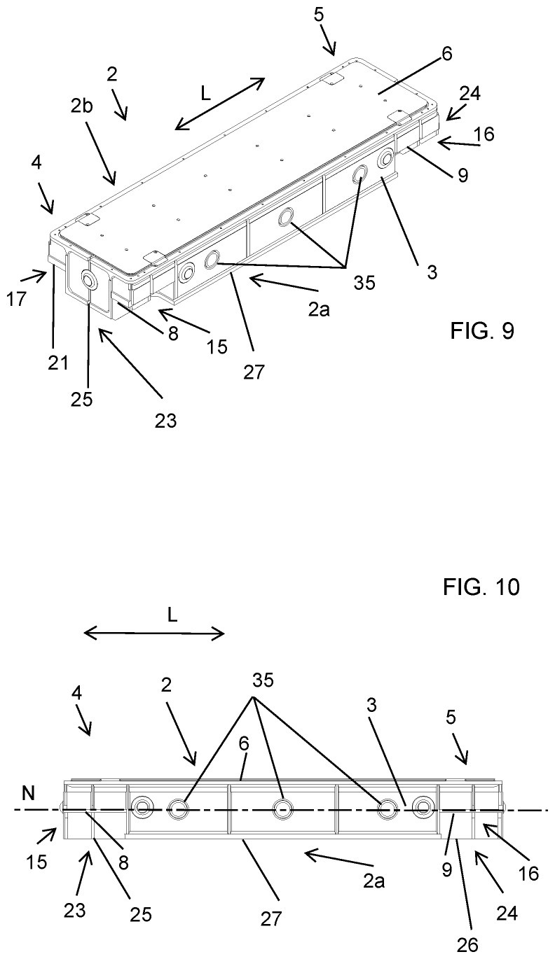

FIGS. 7 and 8 illustrate this embodiment.

Alternatively, the plurality of abutments (14) can comprise a plurality of lubricating contacts (not illustrated).

The abutments of the plurality of abutments (14) limit the horizontal displacements of the beam (2) subjected to the load of the vehicle in transit.

The lateral walls of the seat (11) preferably form a plurality of projections and recesses (32) which are arranged in succession to one another; the base (10) comprises a rest surface (33) for restingly receiving the first cover (28); the plurality of projections and recesses (32) form additional rest surfaces (34) coplanar to the rest surface (33).

In detail, when the beam (2) is received in the seat (11), the first upper rest surface (6), the rest surface (33) and the additional rest surfaces (33) are aligned to one another (see FIG. 13).

By increasing the extension of the rest surface (33) for the first cover (28), the phenomenon of vibration of the first cover (28) is limited, following the transit of a vehicle.

Each abutment of the plurality of abutments (14) preferably defines, at the beam (2), a corresponding area (A); the area (A) being crossed by the horizontal plane defined by the neutral axis (N) of the beam (2) (see FIG. 8).

The value of the force that can act laterally on the compression load cells (12, 13, 19, 20) is advantageously limited.

The beam (2) preferably comprises a plurality of tubular elements (35) arranged internally of the hollow longitudinal body (3) and in such a way as to extend transversally and/or parallel to the relative longitudinal axis (L) (see FIGS. 6, 9-12).

In this way the value of the rigidity to flexion of the beam (2) is advantageously increased.

The plurality of tubular elements (35) can be made of metal.

It is specified that, for the purpose of determining the mass of the vehicle in transit, the dynamic weighing system (1) object of the present invention, comprises a second beam (36) which is arranged flanked to the beam (2); a second plurality of compression load cells (37); a second plurality of abutments (38) (see FIGS. 1-3, 13 and 14).

The same considerations as above for the beam (2), for the plurality of compression load cells (42) and for the plurality of abutments (14) as also valid for the second beam (36), for the second plurality of compression load cells (37) and for the second plurality of abutments (38).

In detail, the beam (2) and the second beam (36) are received in the seat (11) of the base (10) and a metal sheet (39) is interposed between them (see FIG. 13).

Some abutments of the plurality of abutments (14) and the second plurality of abutments (38) are interposed between the metal sheet (39) and the beam (2) and between the metal sheet (39) and the second beam (36).

With particular reference to FIGS. 1-3, 13 and 14, the dynamic weighing system of a vehicle (1) is illustrated comprising the second beam (36), the second plurality of compression load cells (37) and the second plurality of abutments (38).

FIG. 3 particularly includes schematic illustrations, in a broken line, of a pair of wheels (7, 70) of a vehicle in transit on the dynamic weighing system (1) object of the present invention.

For the conversion of the value of the force detected by the compression load cells (12, 13, 19, 20) in the value of the mass of the object that has generated the force, for the purpose of reducing error to a minimum, it is assumed that the frequency of the first vibration mode of the beam (2) itself, as it is a supported beam (2) having a degree of freedom, is greater than the strain frequency to which the beam (2) by effect of the vehicle in transit thereon is subjected.

For the purpose of verifying this condition, the beam (2) must be light but also stiff.

For this reason, the beam (2) comprises a hollow longitudinal body (3) and is provided with stiffening elements, i.e. the plurality of tubular elements (35), which are arranged transversally and/or parallel to the relative longitudinal axis (L).

For the sake of clarity, the following describes how to calculate the frequency on the first vibration mode (indicated as fₚ) of the beam (2), i.e:

fₚ=√(k/m),

where k is the value of the rigidity to flexion of the beam (2) and m is the value of the mass of the beam (2).

From the above formula, it can be deduced that, fixed to the value of the rigidity to flexion of the beam (2), on reducing the value of the mass the value of the frequency on the first vibration mode of the beam (2) increases.

Further, we describe in the following how the frequency of oscillation is calculated (indicated as fₛ) to which the beam (2) by effect of the vehicle in transit thereon is subjected, i.e:

fₛ=(v/(W+I)),

where v is the value of velocity at which the vehicle travels through the beam (2), W is the value of the dimension of the beam (2) along the direction of motion of the vehicle and I is the value of the minimum dimension of the wheel (7) of the vehicle, i.e. of the impression of the vehicle on the beam (2) in the direction of motion.

Again with reference to the mode of conversion of the value of the force detected by the compression load cells (12, 13, 19, 20) in the value of the mass of the object that has generated the force, it is appropriate also to reduce to a minimum the errors generated by the frequency of oscillation of the vehicle as a function of the roughness of the road surface or the relative braking operations.

In this matter, it has been demonstrated by the inventor that a reduction in these errors is obtained by increasing the number of measurements of the value of the force.

For this reason, a preferred embodiment of the dynamic weighing system of a vehicle (1) includes two pairs of beams (2, 36 and 40, 41) arranged mutually flanked in such a way that, during the transit of a vehicle, a first pair of beams (2, 36) detects the force exerted by the wheels arranged along a vehicle axis and the second pair of wheels (40, 41) detects the force exerted by the wheels arranged along a second vehicle axis.

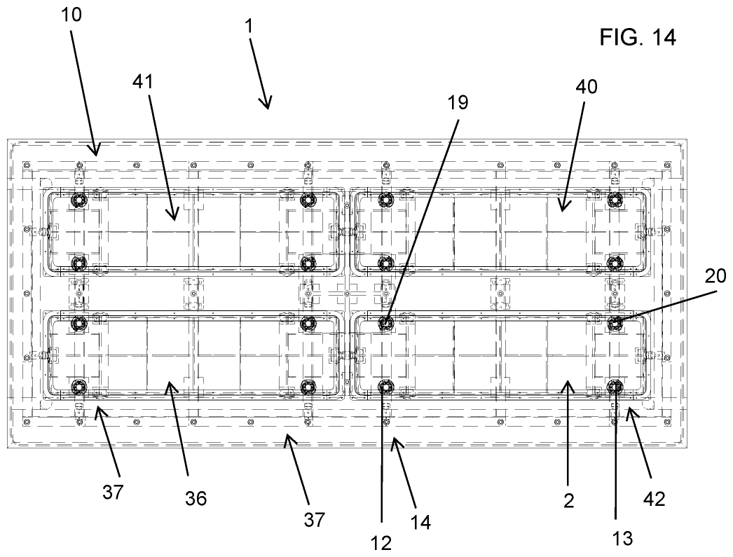

This last embodiment is illustrated in FIG. 14, in which broken lines are used to detail the characteristics of the dynamic weighing system of a vehicle as described above.

1. A dynamic weighing system of a vehicle comprising:
a beam comprising:
a hollow longitudinal body;
a first end portion and a second end portion which are opposite one another and parallel to one another and which comprise a part of the relative neutral axis of the beam;
the first end portion and the second end portion having a relative transversal section that is smaller than the transversal section of the remaining portion of the beam;
an upper rest surface for receiving the wheel of a vehicle in transit;
a first lower rest surface which is arranged at the first end portion and a second lower rest surface which is arranged at the second end portion;
the first lower rest surface and the second lower rest surface being opposite the upper rest surface and extending on the horizontal plane defined by the neutral axis of the beam;
a base to be arranged in such a way as to be beneath the road surface and comprising a seat conformed so as to receive the beam;
a plurality of compression load cells which are interposed between the base and the beam in such a way that at least a first compression load cell supports the beam at the first lower rest surface and the at least a second compression load cell supports the beam at the second lower rest surface;
a plurality of abutments which are interposed between the beam and the lateral walls of the seat so as to limit the displacements of the beam along a transversal direction to the relative longitudinal axis;
the dynamic weighing system of a vehicle being configured in such a way that, during the transit of a wheel of the vehicle on the upper rest surface, the at least a first compression load cell and the at least a second compression load cell detect the force exerted when abutting, respectively, the first lower rest surface and the second lower rest surface.

2. The dynamic weighing system of a vehicle claim 1, wherein:
the first end portion comprises a first step which extends at least partially along a first longitudinal edge of the beam;
the second end portion comprises a second step which extends at least partially along the first longitudinal edge of the beam;
the at least a first compression load cell is arranged to abut the first step;
the at least a second compression load cell is arranged to abut the second step.

3. The dynamic weighing system of a vehicle of claim 2, wherein:
the first end portion comprises a third step which is opposite the first step and which extends at least partially along a second longitudinal edge of the beam;
the second end portion comprises a fourth step which is opposite the second step and which extends at least partially along the second longitudinal edge of the beam;
the plurality of compression load cells comprises: a third compression load cell which is arranged so as to abut the third step and a fourth compression load cell which is arranged so as to abut the fourth step.

4. The dynamic weighing system of a vehicle of claim 3, wherein:
the first end portion comprises a first projection which is interposed between the first step and the third step and which is conformed so as to abut the base, when the beam is received in the seat;
the second end portion comprises a second projection which is interposed between the second step and the fourth step and which is conformed so as to abut the base, when the beam is received in the seat.

5. The dynamic weighing system of a vehicle of claim 1, further including a first cover conformed so as to superiorly cover the base and comprising a through-opening which is conformed and dimensioned so as to place the first upper rest surface in communication with outside, when the first cover covers the base and the beam is accommodated in the seat.

6. The dynamic weighing system of a vehicle of claim 5, further including a second cover conformed so as to cover the through-opening.

7. The dynamic weighing system of a vehicle claim 1, wherein the base is made of reinforced concrete.

8. The dynamic weighing system of a vehicle claim 5, wherein:
the lateral walls of the seat form a plurality of projections and recesses which are arranged in succession to one another;
the base comprises a rest surface for restingly receiving the first cover;
the plurality of projections and recesses form additional rest surfaces coplanar to the rest surface.

9. The dynamic weighing system of a vehicle claim 1, wherein each abutment of the plurality of abutments defines, at the beam, a corresponding area; the area being crossed by the horizontal plane defined by the neutral axis of the beam.

10. The dynamic weighing system of a vehicle claim 1, wherein the beam comprises a plurality of tubular elements arranged internally of the hollow longitudinal body and in such a way as to extend transversally and/or parallel to the relative longitudinal axis.

11. The dynamic weighing system of a vehicle of claim 6, wherein:
the lateral walls of the seat form a plurality of projections and recesses which are arranged in succession to one another;
the base comprises a rest surface for restingly receiving the first cover;
the plurality of projections and recesses form additional rest surfaces coplanar to the rest surface.

12. A dynamic weighing system of a vehicle comprising:
a beam comprising:
a hollow longitudinal body;
a first end portion and a second end portion which are opposite one another and parallel to one another and which comprise a part of the relative neutral axis of the beam, the first end portion comprises a first step which extends at least partially along a first longitudinal edge of the beam, the second end portion comprises a second step which extends at least partially along the first longitudinal edge of the beam;
the first end portion and the second end portion having a relative transversal section that is smaller than the transversal section of the remaining portion of the beam;
an upper rest surface for receiving the wheel of a vehicle in transit;
a first lower rest surface which is arranged at the first end portion and a second lower rest surface which is arranged at the second end portion;
the first lower rest surface and the second lower rest surface being opposite the upper rest surface and extending on the horizontal plane defined by the neutral axis of the beam;
a base to be arranged in such a way as to be beneath the road surface and comprising a seat conformed so as to receive the beam;
a plurality of compression load cells which are interposed between the base and the beam in such a way that at least a first compression load cell supports the beam at the first lower rest surface and the at least a second compression load cell supports the beam at the second lower rest surface, the at least a first compression load cell is arranged to abut the first step, and the at least a second compression load cell is arranged to abut the second step;
a plurality of abutments which are interposed between the beam and the lateral walls of the seat so as to limit the displacements of the beam along a transversal direction to the relative longitudinal axis, each abutment of the plurality of abutments defines, at the beam, a corresponding area, the area being crossed by the horizontal plane defined by the neutral axis of the beam;
the dynamic weighing system of a vehicle being configured in such a way that, during the transit of a wheel of the vehicle on the upper rest surface, the at least a first compression load cell and the at least a second compression load cell detect the force exerted when abutting, respectively, the first lower rest surface and the second lower rest surface (9).

13. The dynamic weighing system of a vehicle of claim 12, wherein:
the first end portion comprises a third step which is opposite the first step and which extends at least partially along a second longitudinal edge of the beam;
the second end portion comprises a fourth step which is opposite the second step and which extends at least partially along the second longitudinal edge of the beam;
the plurality of compression load cells comprises: a third compression load cell which is arranged so as to abut the third step and a fourth compression load cell which is arranged so as to abut the fourth step.

14. The dynamic weighing system of a vehicle of claim 13, wherein:
the first end portion comprises a first projection which is interposed between the first step and the third step and which is conformed so as to abut the base, when the beam is received in the seat;
the second end portion comprises a second projection which is interposed between the second step and the fourth step and which is conformed so as to abut the base, when the beam is received in the seat.

15. The dynamic weighing system of a vehicle of claim 12, further including a first cover conformed so as to superiorly cover the base and comprising a through-opening which is conformed and dimensioned so as to place the first upper rest surface in communication with outside, when the first cover covers the base and the beam is accommodated in the seat.

16. The dynamic weighing system of a vehicle of claim 15, further including a second cover conformed so as to cover the through-opening.

17. The dynamic weighing system of a vehicle of claim 12, wherein the base is made of reinforced concrete.

18. The dynamic weighing system of a vehicle of claim 15, wherein:
the lateral walls of the seat form a plurality of projections and recesses which are arranged in succession to one another;
the base comprises a rest surface for restingly receiving the first cover;
the plurality of projections and recesses form additional rest surfaces coplanar to the rest surface.

19. The dynamic weighing system of a vehicle of claim 16, wherein:
the lateral walls of the seat form a plurality of projections and recesses which are arranged in succession to one another;
the base comprises a rest surface for restingly receiving the first cover;
the plurality of projections and recesses form additional rest surfaces coplanar to the rest surface.

20. The dynamic weighing system of a vehicle of claim 12, wherein the beam comprises a plurality of tubular elements arranged internally of the hollow longitudinal body and in such a way as to extend transversally and/or parallel to the relative longitudinal axis.
